(19) United States
(12) Patent Application Publication
(10) Pub. No.: US 2025/0124046 A1
(43) Pub. Date: Apr. 17, 2025

(54) VISUALIZATION FOR MANAGING HYDROCARBON WELLS

(71) Applicant: Halliburton Energy Services, Inc., Houston, TX (US)

(72) Inventors: Alexander Simon Chretien, Houston, TX (US); Andreas Sadlier, Houston, TX (US); Beth Reidy, Houston, TX (US)

(21) Appl. No.: 18/484,595

(22) Filed: Oct. 11, 2023

(51) Int. Cl. G06F 16/26; G06F 16/28; G06F 16/901

(52) U.S. Cl. CPC G06F 16/26; G06F 16/288; G06F 16/9024

(57) ABSTRACT

A method for managing one or more hydrocarbon wells. The method comprises obtaining a well dataset for the one or more hydrocarbon wells and identifying one or more entities within the well dataset, wherein each of the one or more entities has at least one corresponding well attribute and corresponding entity dates. The method comprises generating a network graph of the one or more entities based on a similarity index between the one or more entities, wherein the similarity index utilizes the corresponding well attributes. The method comprises identifying a first cluster of the one or more entities within the network graph, wherein the one or more entities within the first cluster correspond to a first hydrocarbon well of the one or more hydrocarbon wells. The method comprises generating, on a display device, a visualization of the first hydrocarbon well including the one or more entities of the first cluster.

### TECHNICAL FIELD

This disclosure relates generally to the field of hydrocarbon well operations and more particularly to the field of generating a visualization for managing hydrocarbon well operations.

### BACKGROUND

The exploration and extraction of hydrocarbons from the Earth's subsurface includes many operations, services, and/or data. A wellbore may be drilled into a hydrocarbon-bearing reservoir within the subsurface, and data may be gathered during the drilling process to characterize the hydrocarbon-bearing reservoir and potential recoverable hydrocarbon volumes stored within the reservoir. The wellbore may then be completed (i.e., cemented, hydraulically fractured, etc.) to allow the hydrocarbons to flow to the surface. Each of the operations performed on the well, an offset well, wells with similar characteristics, etc. may be utilized to manage future operations on one or more wells. For example, historical well data (e.g., drilling data, completions data, production data, etc.) may be utilized to manage future operations in an attempt to increase production of hydrocarbons from the reservoir.

### BRIEF DESCRIPTION OF THE DRAWINGS

Implementations of the disclosure may be better understood by referencing the accompanying drawings.

FIGS. 1A-1B are schematics of exemplary systems for hydrocarbon well operations, according to some implementations.

FIG. 2 is a conceptual diagram depicting an example timeline generator, according to some implementations.

FIG. 3 is a flowchart depicting example operations for generating a network graph, according to some implementations.

FIG. 4 is a continuation of FIG. 3 and is a flowchart depicting example operations for generating wellbore operations based on visualization, according to some implementations.

FIGS. 5A-5C are charts depicting example network graphs, according to some implementations.

FIG. 6 is an illustration depicting an example timeline, according to some implementations.

FIG. 7 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. For instance, this disclosure refers to utilizing a network graph to generate a visualization of services performed on a wellbore. Aspects of this disclosure can also be applied to other methods for generating the visualization. For clarity, some well-known instruction instances, protocols, structures, and operations have been omitted.

The exploration and production of hydrocarbons from the Earth's surface may include many activities. Activities may include exploration of the Earth's surface to identify hydrocarbon-bearing reservoirs, drilling of one or more hydrocarbon wells in the reservoirs, hydraulically fracturing the reservoirs via the wells, logging each respective well, installing artificial lift systems in the respective wells, etc. Each respective activity performed on a well may include corresponding datasets with potentially valuable information that may be utilized in managing future operations for the wells. For example, geological data, completion data, production data, etc. of a well drilled in a reservoir may be utilized to design an offset wellbore that may be drilled in the same reservoir. In some implementations, the data for respective activities may be obtained from a plurality of systems such as public datasets, third party, internal systems, etc. For example, lease information may be with a public system, drilling data may be with a drilling company, production data may be with an operator, etc. In some implementations, a visualization (such as a timeline, Gantt chart, group of related activities, etc.) of a hydrocarbon well's activities (i.e., entities) may be generated to display the history of one or more wells and assist in managing hydrocarbon operations by integrating the datasets from different entities of the hydrocarbon well (or group of related hydrocarbon wells). To do so, each of the entities may require being connected to one another via common well attributes between entities to confirm the entities correspond to one or more wells. For example, if a well name corresponding to a drilling dataset for a drilling service is similar to a well name corresponding to a logging dataset for a logging service, then a connection may be made between the two entities because the two entities may be associated with the same hydrocarbon well. Conventional approaches may have difficulty integrating entities for one or more wells and/or generating a visualization of the entities to be displayed and be utilized for managing hydrocarbon well operations. For example, conventional approaches may rely on a direct match of well attribute metadata to connect entities. In some implementations, the data for different entities may not match precisely, data may be missing or may have different semantic, the metadata may be unstructured, etc., which may lead to challenges in connecting each entity and subsequently generating a visualization of the entities.

In some implementations, relationships between entities of one or more hydrocarbon wells may be detected to connect entities and generate a visualization of the one or more hydrocarbon wells. A well dataset for one or more hydrocarbon wells may be obtained from sources including public records, internal systems, third party systems, etc. The well dataset may include entities such as a well job, well activity, public record, etc. from one or more wells. Each of the entities may include one or more corresponding well attributes such as a well identifier (e.g., an American Petroleum Institute (API) number), a well name, operator name, surface location coordinates, etc. In some implementations, each of the entities may also include an entity date which may correspond to the date the entity was performed, the date the corresponding entity data was collected, etc. In some implementations, each of the well attributes may be tokenized. For example, techniques such as natural language processing (NLP) may be utilized to tokenize the textual data of the well attributes for each entity. Each of the tokenized well attributes may be utilized to generate a similarity index between the entities and subsequently generate a network graph of the entities. By increasing a similarity threshold, one or more clusters of entities may be identified within the network graph. In some implementations, the geo-spatial autocorrelation may be generated for the entities within each cluster to refine each cluster. In some implementations, each refined cluster may represent a potential hydrocarbon well or group of hydrocarbon wells, where the entities within each cluster are identified as entities corresponding to said hydrocarbon well or group of hydrocarbon wells.

In some implementations, the entities of a cluster may be plotted with respect to the entity dates to generate a visualization of the hydrocarbon well or group of hydrocarbon wells. The visualization may include a timeline of the entities displayed in chronological order, a Gantt chart of the entities, or any other suitable visualization to display the entities with a time attribute. In some implementations, the visualization may not display the entities based on time attributes. For example, the visualization may include a group of related entities, whether the respective entities have a corresponding time attribute or not. Each entity on the visualization may be displayed with an icon and a respective entity summary. For example, a hydraulic fracturing job of a hydrocarbon well displayed on the timeline may include a chart of stage data and a summary of the hydraulic fracturing job. An expanded view of each entity may be displayed in response to a first user interaction. For example, a user may click on the hydraulic fracturing icon to display the well dataset corresponding to the hydraulic fracturing job such as number of stages, sand volumes pumped, average treating pressure, etc.

The visualization of one or more hydrocarbon wells may present a lifecycle time series of the one or more hydrocarbon wells, assisting in the visualization of the historical operations on the well through the linking datasets. In some implementations, the visualization may be utilized to manage operations on the hydrocarbon well, group of hydrocarbon wells, or future hydrocarbon wells. For example, operations may be initiated, modified, or stopped based on the visualization. Examples of operations include designing and installation of an artificial lift system into a hydrocarbon well, designing a hydraulic fracturing plan of an offset well, drilling a well in the reservoir, shutting in a hydrocarbon well, etc. For instance, the visualization may provide details of a hydraulic fracturing job and production data on a well drilled in a reservoir. Accordingly, a hydraulic fracturing job may be designed for an offset well drilled in the same reservoir based on the job details and production data of the original well. In some implementations, the visualization may be input into recommendations systems that may automatically generate recommended operations.

### Example System

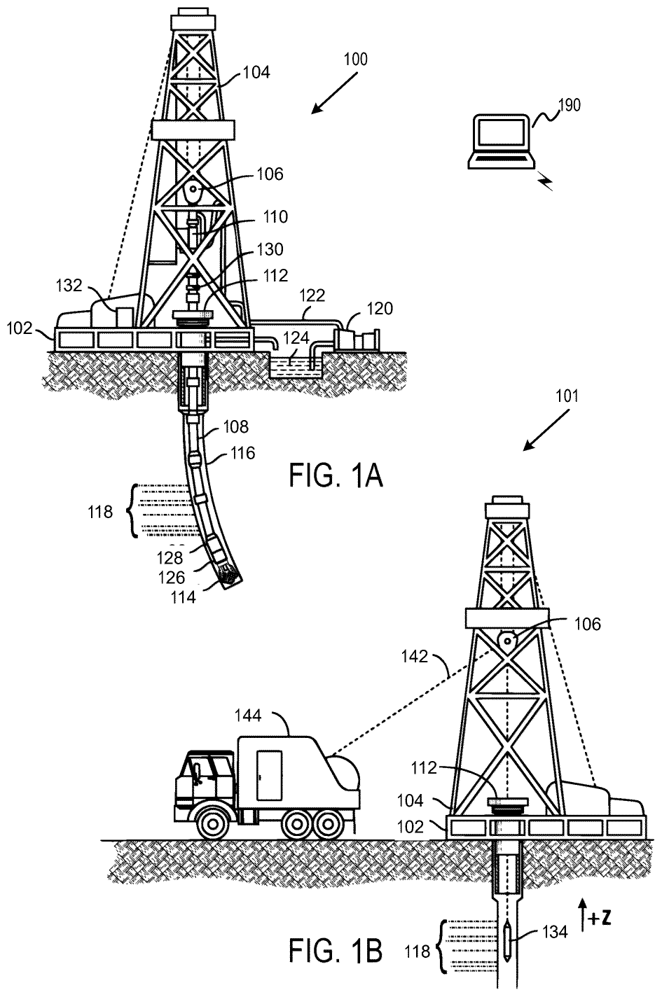

FIGS. 1A-1B are schematics of exemplary systems for hydrocarbon well operations, according to some implementations. FIG. 1A depicts an example drilling system 100. A drilling platform 102 supports a derrick 104 having a traveling block 106 for raising and lowering a drill string 108. A kelly 110 supports the drill string 108 as it is lowered through a rotary table 112. A drill bit 114 is driven by a downhole motor and/or rotation of the drill string 108. As the drill bit 114 rotates, it creates a wellbore 116 that passes through various subsurface formations 118. A pump 120 circulates drilling fluid through a feed pipe 122 to the kelly 110, downhole through the interior of the drill string 108, through orifices in the drill bit 114, back to the surface via the annulus around the drill string 108, and into a retention pit 124. The drilling fluid transports cuttings from the borehole into the retention pit 124 and aids in maintaining the borehole integrity.

A downhole tool 126 can be integrated into the bottom-hole assembly near the drill bit 114. In some implementations, the downhole tool 126 may include any of a number of different types of tools including a rotary steerable system (RSS), measurement while drilling (MWD) tools, logging while drilling (LWD) tools, mud motors, etc. For purposes of communication, a downhole telemetry sub 128 can be included in the downhole tool 126 to transfer measurement data to a surface receiver 130 and to receive commands from the surface. Mud pulse telemetry is one common telemetry technique for transferring tool measurements to surface receivers and receiving commands from the surface, but other telemetry techniques can also be used. In some implementations, the downhole telemetry sub 128 can store logging data for later retrieval at the surface when the logging assembly is recovered.

At the surface, the surface receiver 130 can receive the uplink signal from the downhole telemetry sub 128 and can communicate the signal to a data acquisition module 132. The data acquisition module 132 can include one or more processors, storage mediums, input devices, output devices, software, etc. The data acquisition module 132 can collect, store, and/or process the data received from the bottom-hole assembly.

At various times during the drilling process, the drill string 108 may be removed from the wellbore 116 as shown in FIG. 1B. FIG. 1B depicts an example wireline system 101 with a wireline tool 134 positioned in the wellbore 116 after the drill string 108 is removed.

Once the drill string has been removed, logging operations can be conducted using a wireline tool 134 (i.e., a sensing instrument sonde suspended by a cable 142 having conductors for transporting power to the tool and telemetry from the tool to the surface). The wireline tool 134 may have pads and/or centralizing springs to maintain the tool near the central axis of the borehole or to bias the tool towards the borehole wall as the tool is moved downhole or uphole. The wireline tool 134 can also include one or more navigational packages for determining the position, inclination angle, horizontal angle, and rotational angle of the tool. Such navigational packages can include, for example, accelerometers, magnetometers, and/or sensors. In some implementations, a surface measurement system (not shown) can be used to determine the depth of the wireline tool 134.

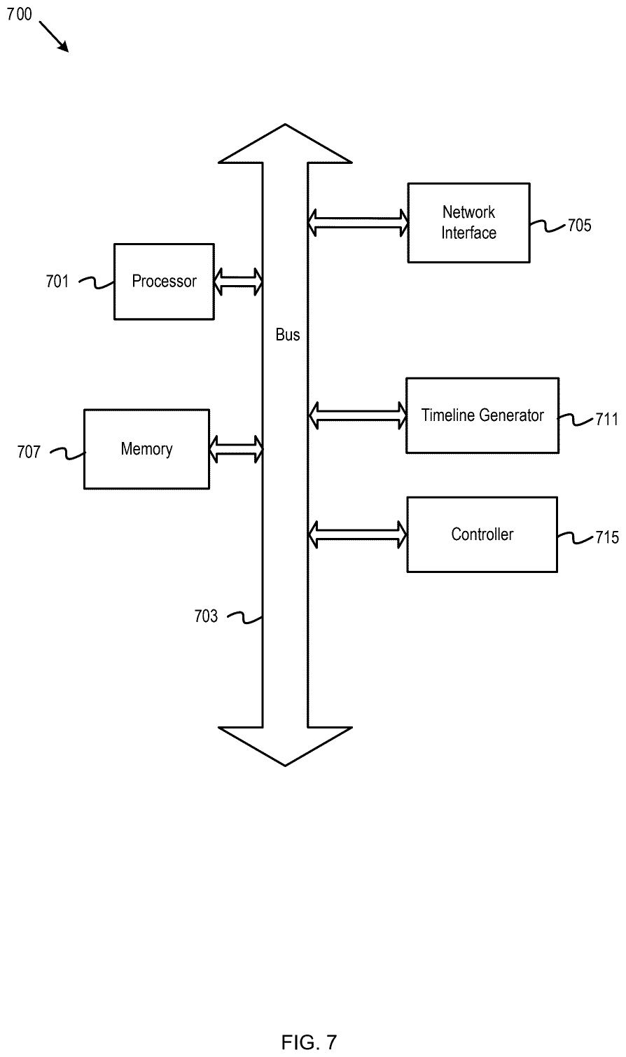

The drilling system 100 and/or the wireline system 101 includes a computer 190 that may be communicatively coupled to other parts of the drilling system 100 and/or wireline system 101. Additionally, the computer 190 may be communicatively coupled to other systems such as a hydraulic fracturing system (not pictured). The computer 190 may be local or remote to the drilling system 100 and/or the wireline system 101. A processor of the computer 190 may have perform commands (as further described below) to integrate service operation data with other datasets relating to the wellbore 116 to generate a visualization of the wellbore 116. An example of the computer 190 is depicted in FIG. 7, which is further described below.

Although FIGS. 1A and 1B depict specific borehole configurations, it should be understood by those skilled in the art that the present disclosure is equally well suited for use in wellbores having other orientations including vertical wellbores, horizontal wellbores, slanted wellbores, multilateral wellbores and the like. Also, even though FIGS. 1A and 1B depict an onshore operation, it should be understood by those skilled in the art that the present disclosure is equally well suited for use in offshore operations. Moreover, it should be understood by those skilled in the art that the present disclosure is not limited to the environments depicted in FIGS. 1A and 1B, and can also be used, for example, in other operations such as hydraulic fracturing operations, coiled tubing operations, production operations, a combinations thereof, and the like.

### Example Operations

Example operations for generating a visualization are now described.

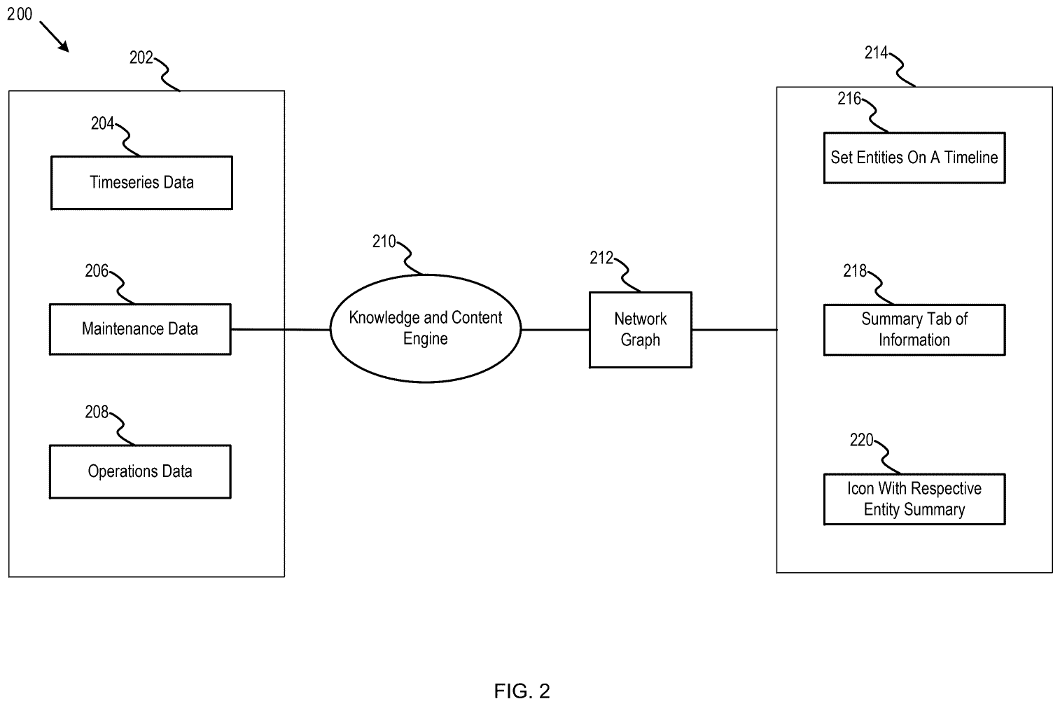

FIG. 2 is a conceptual diagram depicting an example timeline generator, according to some implementations. FIG. 2 includes a timeline generator 200 that includes a tokenizer 202 and a visualization generator 214. In some implementation, the tokenizer 202 may by any suitable system configured to tokenize well attributes. Operations of the timeline generator 200 are described in reference to the computer 190 of FIG. 1. The computer 190 may perform any or all operations described with reference to FIG. 2. The timeline generator 200 may be implemented for the purpose of generating one or more visualization for one or more hydrocarbon wells.

A well dataset from one or more hydrocarbon wells may be obtained and input into the tokenizer 202. The well dataset may include entities such as jobs, activities, public records, etc. and their corresponding data. The data may include timeseries data 204, maintenance data 206, operations data 208, or any other suitable data from one or more entities of a hydrocarbon well. Additionally, each entity may include one or more corresponding well attribute such as well name, API number, operator, surface location coordinates, etc. The tokenizer 202 may tokenize each well attribute for each entity. For example, natural language processing (NLP) tokenization may be utilized to tokenize the textual data of the well attribute metadata. The tokenization of the well attributes may allow similar well attributes between entities to be detected. Detection through the tokenized well attributes may reduce and/or eliminate the error when attempting to connect entities with exact matching well attributes. For example, two entities may be related to the same well. A well name for one entity may be “Smith #1”, and a well name for another entity may be “Smith 1”. If related entities are detected based on an exact match of the well name well attribute, the relationship between these two entities may not be detected due to the well name of the respective entities being slightly different. Tokenization of this well attribute may reduce the error in detecting the relationship between the two entities.

The tokenized well attributes may then be input into a knowledge and content engine 210 to generate a network graph 212. The knowledge and content engine 210 may identify each entity and generate a similarity index between entities utilizing the tokenized well attributes for the respective entities, resulting in a connection of related entities. For example, the range of the similarity index may be from 0 to 1, where 0 is no relation between one or more well attributes between entities and 1 is the exact match of one or more well attributes between entities. Each of the entities may be represented by a node within the network graph and the similarity index between the nodes may be represented by edges of the network graph. A similarity threshold may be raised to identify clusters of entities within the network graph. For example, the similarity threshold may be raised from 0 to 0.75, resulting in edges connecting nodes with similarity index above 0.75 being displayed on the network graph. For instance, raising the similarity threshold may reveal a cluster of entities corresponding to a group of wells drilled on a single pad on the Earth's surface and producing hydrocarbons from the same formation. The entities for each of the clusters may range from early in the life of a well (seismic operations, exploratory operations, etc.) to recent entities (logging, artificial lift installation or replacement, etc.). Additionally, production data from the well back to first production may be available. In some implementations, the geo-spatial autocorrelation between entities within each cluster may be generated to further refine each cluster. For example, the network graph may be further filtered to positive autocorrelations of similarity coefficients, resulting in entities with similar surface hole locations.

The network graph 212 may then be input into visualization generator 214 to generate a timeline (or any other suitable aforementioned visualizations) of the entities within each cluster. The visualization generator 214 may generate a set of entities on a timeline 216 in chronological order. Each entity may be displayed with an icon with respective entity summary 220 on the timeline. In some implementations, each icon may be configured with tooltip information, where a user interaction may display additional information about the respective entity. Additionally, the visualization generator 214 may generate a summary tab of information 218 of the entities from the cluster input into the visualization generator 214.

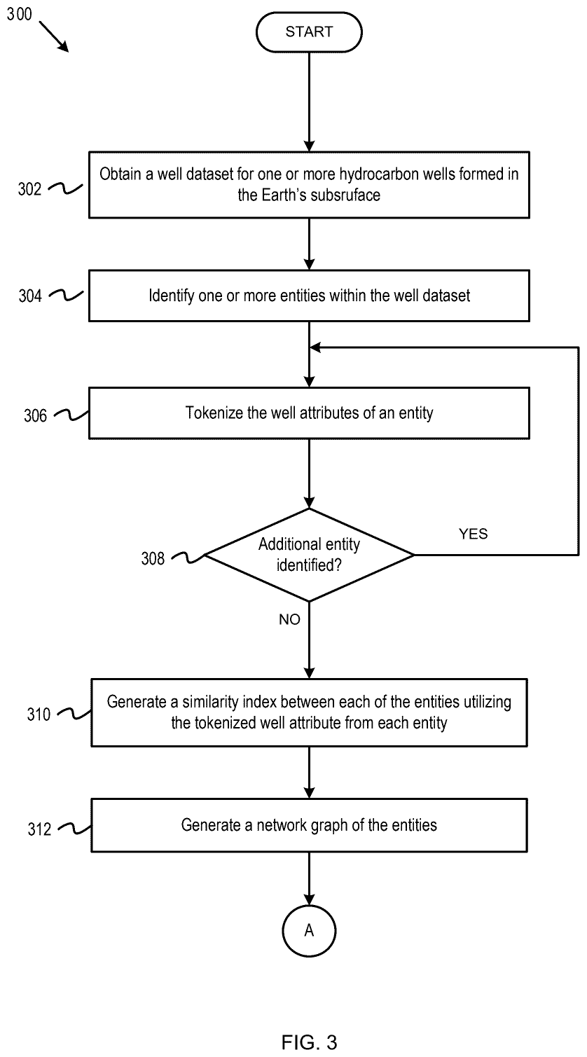

FIG. 3 is a flowchart depicting example operations for generating a network graph, according to some implementations. FIG. 3 includes a flowchart 300 for generating a network graph of entities from one or more hydrocarbon wells. Operations of flowchart 300 of FIG. 3 are described in reference to the processor of the computer 190 of FIG. 1. Additionally, the operations of flowchart 300 are described in reference to the timeline generator 200 of FIG. 2. Operations of the flowchart 300 start at block 302.

At block 302, the processor of the computer 190 may obtain a well dataset for one or more hydrocarbon wells formed in the Earth's subsurface. The well dataset may include entities and associated data from each well. Entities from each well may include a job (such as drilling the well, hydraulic fracturing the well, etc.), an activity (such as replacing the artificial lift system, coiled tubing cleanout, etc.), public records (drilling permits, lease information, etc.), production volumes through the life of the well, etc. Each of the entities may include one or more well attributes. Well attributes may include metadata such as well name, API number, operator, surface hole location, etc. In some implementations, the well attributes may include textual data or any other suitable data that may be tokenized.

At block 304, the processor of the computer 190 may identify one or more entities within the well dataset. Each of the entities may be manually or automatically identified. In some implementations, each entity may be labeled with the respective entity title. For example, an entity related to production throughout the life of the well may be labeled as production.

At block 306, the processor of the computer 190 may tokenize the well attributes of an entity. The entity may be selected from the one or more entities identified in block 304. In some implementations, a tokenizer (such as tokenizer 202 of FIG. 2) may break the text (structured and/or unstructured) of the entity's respective well attributes into segments that may be considered discrete elements. For example, the tokenizer may segment the well attribute may be segmented into phrases, words, groups of characters, individual characters, etc. based on the contents of each well attribute to tokenize the well attributes. Any suitable tokenizer may be utilized to tokenize the well attributes for an entity, such as natural language processing (NLP) techniques. In some implementations, the tokenizer may store each of the token in index with occurrence by entity.

At block 308, the processor of the computer 190 may determine if there are additional entities identified in the well dataset. If additional entities have been identified, then operations may return to block 306 to tokenize the well attributes of the next entity. Otherwise, operations may proceed to block 310.

At block 310, the processor of the computer 190 may generate a similarity index between each of the entities utilizing the tokenized well attributes from each entity. A Jaccard index or any other suitable similarity index techniques may be utilized to generate a similarity index between entities. The similarity index may determine the similarity between tokenized well attributes of entities. In some implementations, the similarity index may utilize a scale, such as a scale ranging from 0 to 1, where 0 represents no similarity between one or more tokenized well attributes and 1 represents one or more tokenized well attributes are an exact match. For instance, a well attribute may include a well name and may be tokenized into characters. A similarity index may indicate the similarity between the tokens (characters) of well name attributes for each entity. If the tokens for first entity are an exact match to the tokens of a second entity, then it may be inferred that the two entities belong to the same well.

At block 312, the processor of the computer may generate a network graph of the entities. In some implementations, each node of the network graph may represent an entity and the edges of the network graph may represent the similarity index between entities.

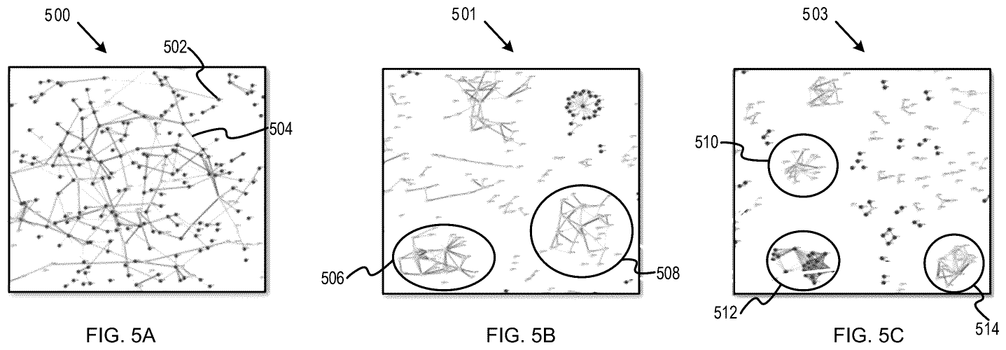

To help illustrate, FIGS. 5A-5C are charts depicting example network graphs, according to some implementations. In particular, FIG. 5A includes a network graph 500. The network graph 500 includes nodes (entities), such as node 502, where each node includes tokenized well attributes. The network graph 500 also includes edges (similarity indexes), such as edge 504, to connect related nodes based on the tokenized well attributes of the respective nodes.

In some implementations, the edges may be generated on the network graph based on the similarity threshold of the similarity index. A similarity threshold may be set such that edges may only connect nodes if the similarity index between the nodes is greater than or equal to the similarity threshold. For example, the similarity threshold for the network graph 500 may be 0.1, such that only edges with a similarity index greater than or equal to 0.1 may be generated between nodes.

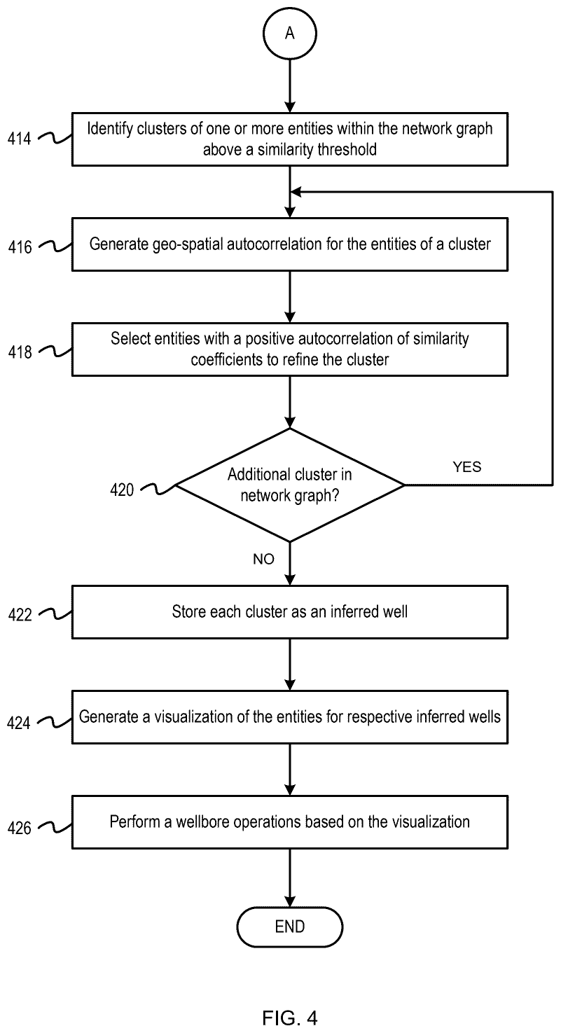

Returning to the operations of flowchart 300. Operations of flowchart 300 continue in FIG. 4.

FIG. 4 is a continuation of FIG. 3 and is a flowchart depicting example operations for generating wellbore operations based on visualization, according to some implementations. In particular, wellbore operations may be generated based on the combined well data within the entities of a visualization. Operations of the flowchart 400 of FIG. 4 are described in reference to the computer 190 of FIG. 1. The computer 190 may perform any or all of the operations described with reference to FIG. 4. Operations of the flowchart 400 start at block 412.

At block 412, the processor of the computer 190 may identify clusters of one or more entities with the network graph above a similarity threshold. A similarity threshold may be increased to identify related entities (i.e., entities related to a potential well or group of wells). The similarity threshold may filter the network graph to only edges and respective nodes with a similarity index greater than or equal to the similarity threshold. This may result in a cluster of entities that may represent one or more wells. For example, a high similarity threshold on a network graph may reveal clusters of entities (nodes), connected by similarity indices (edges), which may infer all entities within the cluster are related to a well (i.e., all jobs, activities, etc. and associated data were performed and obtained on that well, respectively). In some implementations, the clusters of entities may be for more than one well. For example, the similarity threshold may be increased to a level such that clusters of entities are potentially for a group of wells drilled on a single pad. In some implementations, the similarity threshold may be set to a level depending on the what data a user may want to curate. For example, the similarity threshold may be high (i.e., 0.9) to reveal clusters of entities associated with a single well to visualize the activity history of a single well. Alternatively, or in addition to, the similarity threshold may be set to a lower level (i.e., 0.7) to reveal clusters of entities associated with a group of wells such as wells drilled on a single pad, wells operated by an operator in a field/basin, etc. The aforementioned example is for descriptive purposes only. In some implementations, the similarity threshold level may not relate to the number of potential wells in a cluster.

To help illustrate, FIG. 5B of FIG. 5 includes a network graph 501. The network graph 501 depicts the network graph 500 after a similarity threshold has been increased. Clusters, such as cluster 506 and cluster 508 are revealed after the similarity threshold has been increased. Each cluster 506, 508 may represent a potential well or group of wells and the associated entities.

At block 416, the processor of the computer 190 may generate geo-spatial autocorrelation for the entities of a cluster. The geo-spatial autocorrelation may compare the geo-spatial location data (such as the surface hole location of a well) for entities connected with similarity indices to associate entities within the cluster. The geo-spatial autocorrelation may yield both positive and negative autocorrelations of similarity coefficients for connected entities. Negative autocorrelated entities may reveal entities are not associated with the same well. For example, the similarity index between two wells may indicate the tokenized well attributes between the entities were similar, but the negative geo-spatial autocorrelation may reveal that the surface hole location associate with each entity is different, meaning the entities are associated with different wells.

At block 418, the processor of the computer 190 may select entities with a positive autocorrelation of similarity coefficients to refine the cluster. Removal of the negative autocorrelations may further refine the cluster to entities associated with a well or group of wells, resulting in the cluster representing an inferred well. To help illustrate, FIG. 5C of FIG. 5 includes a network graph 503. The network graph 503 is the network graph 501 after negative autocorrelations of similarity coefficients have been removed, resulting in clusters 510, 512, and 514. Each of the clusters 510, 512, and 514 may represent an inferred well or group of inferred wells, where the entities with each cluster are entities associated with respective well or wells.

In some implementations, temporal autocorrelation may be applied to the cluster to further refine the cluster. For example, a well must be drilled before it may be completed. A cluster may include a drilling activity for an inferred well with a respective start date, and a hydraulic fracturing activity with a start date earlier than that of the drilling activity for the same inferred well. The drilling of a well must be performed before the well can be hydraulically fractured. Accordingly, this sequence of activities may result in a negative temporal autocorrelation, and one of the entities may be removed to further refine the cluster.

At block 420, the processor of the computer 190 may determine if there are additional clusters in the network graph. If additional clusters have been identified, then operations may return to block 416 to refine the next cluster. Otherwise, operations may proceed to block 422.

At block 422, the processor of the computer 190 may store each cluster as an inferred well. In some implementations, the cluster may be stored as a group of inferred wells. The member entities and collective well attributes may be stored in index. In some implementations, the collective well attributes for each entity may represent the list of inferred well attributes, e.g., if searching a well attribute hits one entity, all entities on the same well visualization are all returned (see below for visualization details).

At block 424, the processor of the computer 190 may generate a visualization of the entities for the respective inferred wells. In some implementations, the visualization may display all entities in a single display (i.e., on a single display screen of the computer 190). The entities for the one or more wells may be displayed on the timeline, a Gantt chart, or any other suitable visualization to display time series data based on the respective entity date such that the entities may be displayed in chronological order. In some implementations, the production data, including the most recent production data (i.e., the most up-to-date production data that may be obtainable such as real time production data) may be displayed on the right-hand side of the timeline (i.e., after the most recent entity). Each of the entities on the timeline may be displayed as an icon of the curated data associated with the entity and a summary of the associated entity. The timeline may allow a user to visualize all activities, services, etc. performed on one or more wells over the life of the one or more wells. Additionally, the timeline may be utilized for a comparative analysis of multiple wells on a single timeline. For example, a timeline may include a group of wells drilled on from a single pad and the wells are all completed in the same hydrocarbon-bearing reservoir. The timeline may assist in analyzing how production rates of one well were affected when an activity was conducted on another well on the pad (such as hydraulic fracturing, artificial lift installation, etc.).

In some implementations, the visualization may not display the entities of the inferred well based on time attributes. For example, one or more of the entities may not include a corresponding time attribute (such as the entity start date). Accordingly, the visualization may display the entities as a cluster in any suitable display pattern (i.e., not in a chronological order). For example, the entities may be displayed in the visualization as a grid pattern.

When the visualization includes entities for a single well, the visualization at a most zoomed out view may display all associated entities (displayed as icons with summaries) along the visualization, and the production data entity may be displayed on the right-hand side of the visualization (if displayed based on the time attributes). In some implementations, the production data may be displayed at any suitable position along and/or proximate the timeline.

When a visualization includes entities for more than one well, the respective entities may be displayed on a single visualization or multiple visualizations for each respective well. In some implementations, the entities for respective wells may be synchronized to specific dates for comparison such as the date of the well construction, well completion date, etc. Additionally, the production data for each respective well may be displayed on the respective visualization (if displayed based on the time attributes). In some implementations, the multi-well visualization may be configured to generate non-productive time (NPT) and/or comparisons utilizing the entities. For example, the hydraulic fracturing entities for respective wells may be utilized to generate the NPT for each hydraulic fracturing activity on each well.

In some implementations, a first user action (such as selecting/clicking an icon of an entity) may display an expanded view of an entity. For example, selecting an entity for the drilling activity of a well may generate an expanded view of the drilling activity, where the expanded view displays all data from the well dataset corresponding to the drilling activity for the respective well such as drilling permits, drilling logs, drill bit information, etc.

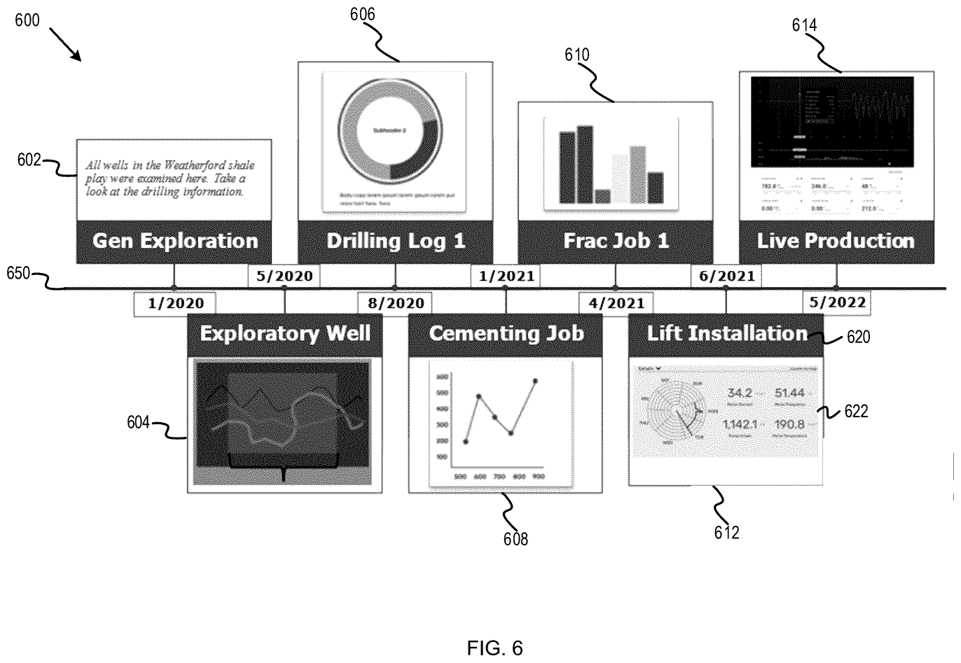

To help illustrate, FIG. 6 is an illustration depicting an example timeline, according to some implementations. FIG. 6 includes a timeline 600 for a single well with an x-axis 650. Curated metadata such as network graphs (e.g., the network graph generated and refined in FIGS. 3-5), data lakes, etc. may be input into a visualization generator (such as visualization generator 214 of FIG. 2) to generate the timeline 600. Entities, such as entities 602-614, are displayed on the x-axis 650 based on the entity dates to display the activity history of the well. Each of the entities may be displayed with an icon and an entity summary, such as icon 622 and entity summary 620 of entity 612, respectively. Icons may include graphs, illustrations, etc. to represent the entity. In some implementations, more details of each entity may be displayed when zooming in on the timeline. For example, additional charts, data on a chart, key data point, etc. may be displayed when zoomed in. In this example illustrations, the production data (entity 614) is displayed on the right-hand side of the x-axis 650. In some implementations, live production data may be included in the production data entity. Although the timeline 600 is for a single well, multiple wells may be overlayed onto the timeline 600. In some implementations, the timelines for each well may be aligned (e.g., at beginning of well services). In some implementations, the timelines may be aligned with service start dates, where a line break from the x-axis 650 may be included to show this.

A user interaction with any of the entities 602-614 may display an expanded view of the entity. For example, selecting the exploratory well activity (entity 604) may display the pre-job plan, billing, permitting, maps, customer information, job logs, etc. Any related artifacts of each entity may be linked to the location of the respective entity on the timeline 600.

In some implementations, a user interaction may display the live view of the timeline 600. For example, selecting the far right side of the timeline (i.e., the most recent date) may display the live view of the well or wells on the timeline with all activities that have occurred to the well.

In some implementations, a timeline model may be generated to analyze the timeline generated with the entities. The timeline model may depict a standard sequence of activities and time between activities performed on a well. The timeline of entities from the cluster may be compared to the timeline model to analyze the fit of the timeline relative to the timeline model. The fit may determine if there is an outlier that may need further analysis, e.g., there is a missing activity, activities are out of order, etc. For example, a well may have been drilled in 1980, and the timeline indicates the first date of production is 2005. When compared to the timeline model, the model indicates there is an outlier due to the time between the drilling activity and the production activity. Further investigation may reveal activities that occurred between the drilling activity and the production activity such as the well was recompleted in a different zone before being produced in 2005.

At block 426, the processor of the computer 190 may perform a wellbore operation based on the visualization. The visualization may be utilized to analyze past activities, performance, etc. to manage future operations on the well. For example, entities associated with logging, artificial lift installation, production history, etc. may be utilized to manage artificial lift operation on the well such as alter pump speeds, reposition components in the well, adjust a choke, etc. In some implementations, a hydraulic fracturing activity may be designed based on data from hydraulic fracturing activity and the resulting well performance (production data) from an offset well drilled in the same reservoir. In some implementations, the visualization may be utilized to predict well performance after well completion activities have been completed, resulting in performing production operations to account for the predicted well performance.

### Example Computer

FIG. 7 is a block diagram depicting an example computer, according to some implementations. FIG. 7 depicts a computer 700 for generating a visualization to manage operations for one or more hydrocarbon wells. The computer 700 includes a processor 701 (possibly including multiple processors, multiple cores, multiple nodes, and/or implementing multi-threading, etc.). The computer 700 includes memory 707. The memory 707 may be system memory or any one or more of the above already described possible realizations of machine-readable media. The computer 700 also includes a bus 703 and a network interface 705. The computer 700 can communicate via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 700 also includes a visualization generator 711 and a controller 715 which may perform the operations described herein. For example, the visualization generator 711 may generate network graph of one or more entities from a well dataset. The visualization generator 711 may also generate a visualization of the one or more respective entities for one or more hydrocarbon wells. The controller 715 may generate an expanded view of the visualization in response to a user interaction with one or more of the timelines. The visualization generator 711 and the controller 715 can be in communication. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for generating a visualization as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Example Implementations

Implementation #1: A computer-implemented method for managing one or more hydrocarbon wells formed in the Earth's subsurface, the computer-implemented method comprising: obtaining a well dataset for the one or more hydrocarbon wells; identifying one or more entities within the well dataset, wherein each of the one or more entities has at least one corresponding well attribute and corresponding entity dates; generating a network graph of the one or more entities based on a similarity index between the one or more entities, wherein the similarity index utilizes the corresponding well attributes; identifying a first cluster of the one or more entities within the network graph, wherein the one or more entities within the first cluster correspond to a first hydrocarbon well of the one or more hydrocarbon wells; and generating, on a display device, a visualization of the first hydrocarbon well including the one or more entities of the first cluster.

Implementation #2: The computer-implemented method of Implementation #1, wherein the one or more entities include a hydrocarbon well job, a hydrocarbon well activity, and a public record.

Implementation #3: The computer-implemented method of Implementation #1 or #2, wherein the one or more well attributes include a well name, a hydrocarbon well identifier, and well surface location coordinates.

Implementation #4: The computer-implemented method of any one or more of Implementations #1-3, wherein the visualization includes a timeline of the one or more entities of the first cluster displayed in chronological order based on the entity date, a Gantt chart of the one or more entities of the first cluster, and a cluster of the one or more entities of the first cluster.

Implementation #5: The computer-implemented method of any one or more of Implementations #1-4 further comprising: tokenizing each of the one or more well attributes for the respective entities; generating the similarity index between the one or more entities utilizing the tokenized well attributes for the respective entities; and generating the network graph of the one or more entities, wherein a node of the network graph represents an entity, and wherein an edge of the network graph represents the similarity index between connected nodes.

Implementation #6: The computer-implemented method of any one or more of Implementations #1-5 further comprising: increasing a similarity threshold of the similarity index; and identifying the first cluster of the one or more entities, wherein the similarity index for the one or more entities are above the similarity threshold.

Implementation #7: The computer-implemented method of any one or more of Implementations #1-6 further comprising: generating geo-spatial autocorrelation between the one or more entities to refine the first cluster, wherein the one or more entities with respective positive autocorrelation of similarity coefficients are selected to refine the first cluster.

Implementation #8: The computer-implemented method of Implementation #7 further comprising: displaying each of the one or more entities from the refined first cluster on the visualization with a respective icon and a respective entity summary; and displaying an expanded view of an entity in response to a first user interaction, wherein the expanded view includes displaying well data from the well dataset corresponding to the entity.

Implementation #9: The computer-implemented method of any one or more of Implementations #1-8 further comprising: identifying the first cluster of the one or more entities within the network graph, wherein the one or more entities within the first cluster correspond to a plurality of hydrocarbon wells of the one or more hydrocarbon wells; and generating, on a display device, the visualization of the plurality of hydrocarbon wells.

Implementation #10: The computer-implemented method of any one or more of Implementations #1-9 further comprising: performing a wellbore operation based on the visualization.

Implementation #11: A non-transitory, computer-readable medium having instructions stored thereon that are executable by a processor to perform operations comprising: obtaining a well dataset for one or more hydrocarbon wells drilled in the Earth's subsurface; identifying one or more entities within the well dataset, wherein each of the one or more entities has at least one corresponding well attribute and corresponding entity dates; generating a network graph of the one or more entities based on a similarity index between the one or more entities, wherein the similarity index utilizes the corresponding well attributes; identifying a first cluster of the one or more entities within the network graph, wherein the one or more entities within the first cluster correspond to a first hydrocarbon well of the one or more hydrocarbon wells; and generating, on a display device, a visualization of the first hydrocarbon well including the one or more entities of the first cluster.

Implementation #12: The non-transitory, computer-readable medium of Implementation #11, wherein the one or more entities include a hydrocarbon well job, a hydrocarbon well activity, and a public record.

Implementation #13: The non-transitory, computer-readable medium of Implementation #11 or #12 further comprising: tokenizing each of the one or more well attributes for the respective entities; generating the similarity index between the one or more entities utilizing the tokenized well attributes for the respective entities; and generating the network graph of the one or more entities, wherein a node of the network graph represents an entity, and wherein an edge of the network graph represents the similarity index between connected nodes.

Implementation #14: The non-transitory, computer-readable medium of any one or more of Implementations #11-13 further comprising: increasing a similarity threshold of the similarity index; and identifying the first cluster of the one or more entities, wherein the similarity index for the one or more entities are above the similarity threshold.

Implementation #15: The non-transitory, computer-readable medium of any one or more of Implementations #11-14 further comprising: generating geo-spatial autocorrelation between the one or more entities to refine the first cluster, wherein the one or more entities with respective positive autocorrelation of similarity coefficients are selected to refine the first cluster.

Implementation #16: The non-transitory, computer-readable medium of Implementation #15 further comprising: displaying each of the one or more entities from the refined first cluster on the visualization with a respective icon and a respective entity summary; and displaying an expanded view of an entity in response to a first user interaction, wherein the expanded view includes displaying well data from the well dataset corresponding to the entity.

Implementation #17: A system comprising: one or more hydrocarbon wells formed in the Earth's subsurface; a processor; and a computer-readable medium having instructions stored thereon that are executable by the processor to cause the processor to, obtain a well dataset for the one or more hydrocarbon wells; identify one or more entities within the well dataset, wherein each of the one or more entities has at least one corresponding well attribute and corresponding entity dates; generate a network graph of the one or more entities based on a similarity index between the one or more entities, wherein the similarity index utilizes the corresponding well attributes; identify a first cluster of the one or more entities within the network graph, wherein the one or more entities within the first cluster correspond to a first hydrocarbon well of the one or more hydrocarbon wells; and generate, on a display device, a visualization of the first hydrocarbon well including the one or more entities of the first cluster.

Implementation #18: The system of Implementation #17 further comprising: tokenizing each of the one or more well attributes for the respective entities; generating the similarity index between the one or more entities utilizing the tokenized well attributes for the respective entities; and generating the network graph of the one or more entities, wherein a node of the network graph represents an entity, and wherein an edge of the network graph represents the similarity index between connected nodes.

Implementation #19: The system of Implementation #17 or #18 further comprising: increasing a similarity threshold of the similarity index; and identifying the first cluster of the one or more entities, wherein the similarity index for the one or more entities are above the similarity threshold.

Implementation #20: The system of any one or more of Implementations #17-19 further comprising: generating geo-spatial autocorrelation between the one or more entities to refine the first cluster, wherein the one or more entities with respective positive autocorrelation of similarity coefficients are selected to refine the first cluster; and displaying each of the one or more entities from the refined first cluster on the visualization with a respective icon and a respective entity summary.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A computer-implemented method for managing one or more hydrocarbon wells formed in the Earth's subsurface, the computer-implemented method comprising:
obtaining a well dataset for the one or more hydrocarbon wells;
identifying one or more entities within the well dataset, wherein each of the one or more entities has at least one corresponding well attribute and corresponding entity dates;
generating a network graph of the one or more entities based on a similarity index between the one or more entities, wherein the similarity index utilizes the corresponding well attributes;
identifying a first cluster of the one or more entities within the network graph, wherein the one or more entities within the first cluster correspond to a first hydrocarbon well of the one or more hydrocarbon wells; and
generating, on a display device, a visualization of the first hydrocarbon well including the one or more entities of the first cluster.

2. The computer-implemented method of claim 1, wherein the one or more entities include a hydrocarbon well job, a hydrocarbon well activity, and a public record.

3. The computer-implemented method of claim 1, wherein the well attributes include a well name, a hydrocarbon well identifier, and well surface location coordinates.

4. The computer-implemented method of claim 1, wherein the visualization includes a timeline of the one or more entities of the first cluster displayed in chronological order based on the entity date, a Gantt chart of the one or more entities of the first cluster, and a cluster of the one or more entities of the first cluster.

5. The computer-implemented method of claim 1 further comprising:
tokenizing each of the well attributes for the respective entities;
generating the similarity index between the one or more entities utilizing the tokenized well attributes for the respective entities; and
generating the network graph of the one or more entities, wherein a node of the network graph represents an entity, and wherein an edge of the network graph represents the similarity index between connected nodes.

6. The computer-implemented method of claim 1 further comprising:
increasing a similarity threshold of the similarity index; and
identifying the first cluster of the one or more entities, wherein the similarity index for the one or more entities are above the similarity threshold.

7. The computer-implemented method of claim 1 further comprising:
generating geo-spatial autocorrelation between the one or more entities to refine the first cluster, wherein the one or more entities with respective positive autocorrelation of similarity coefficients are selected to refine the first cluster.

8. The computer-implemented method of claim 7 further comprising:
displaying each of the one or more entities from the refined first cluster on the visualization with a respective icon and a respective entity summary; and
displaying an expanded view of an entity in response to a first user interaction, wherein the expanded view includes displaying well data from the well dataset corresponding to the entity.

9. The computer-implemented method of claim 1 further comprising:
identifying the first cluster of the one or more entities within the network graph, wherein the one or more entities within the first cluster correspond to a plurality of hydrocarbon wells of the one or more hydrocarbon wells; and
generating, on a display device, the visualization of the plurality of hydrocarbon wells.

10. The computer-implemented method of claim 1 further comprising:
performing a wellbore operation based on the visualization.

11. A non-transitory, computer-readable medium having instructions stored thereon that are executable by a processor to perform operations comprising:
obtaining a well dataset for one or more hydrocarbon wells drilled in the Earth's subsurface;
identifying one or more entities within the well dataset, wherein each of the one or more entities has at least one corresponding well attribute and corresponding entity dates;
generating a network graph of the one or more entities based on a similarity index between the one or more entities, wherein the similarity index utilizes the corresponding well attributes;
identifying a first cluster of the one or more entities within the network graph, wherein the one or more entities within the first cluster correspond to a first hydrocarbon well of the one or more hydrocarbon wells; and
generating, on a display device, a visualization of the first hydrocarbon well including the one or more entities of the first cluster.

12. The non-transitory, computer-readable medium of claim 11, wherein the one or more entities include a hydrocarbon well job, a hydrocarbon well activity, and a public record.

13. The non-transitory, computer-readable medium of claim 11 further comprising:
tokenizing each of the well attributes for the respective entities;
generating the similarity index between the one or more entities utilizing the tokenized well attributes for the respective entities; and
generating the network graph of the one or more entities, wherein a node of the network graph represents an entity, and wherein an edge of the network graph represents the similarity index between connected nodes.

14. The non-transitory, computer-readable medium of claim 11 further comprising:
increasing a similarity threshold of the similarity index; and
identifying the first cluster of the one or more entities, wherein the similarity index for the one or more entities are above the similarity threshold.

15. The non-transitory, computer-readable medium of claim 11 further comprising:
generating geo-spatial autocorrelation between the one or more entities to refine the first cluster, wherein the one or more entities with respective positive autocorrelation of similarity coefficients are selected to refine the first cluster.

16. The non-transitory, computer-readable medium of claim 15 further comprising:
displaying each of the one or more entities from the refined first cluster on the visualization with a respective icon and a respective entity summary; and
displaying an expanded view of an entity in response to a first user interaction, wherein the expanded view includes displaying well data from the well dataset corresponding to the entity.

17. A system comprising:
one or more hydrocarbon wells formed in the Earth's subsurface;
a processor; and
a computer-readable medium having instructions stored thereon that are executable by the processor to cause the processor to,
obtain a well dataset for the one or more hydrocarbon wells;
identify one or more entities within the well dataset, wherein each of the one or more entities has at least one corresponding well attribute and corresponding entity dates;
generate a network graph of the one or more entities based on a similarity index between the one or more entities, wherein the similarity index utilizes the corresponding well attributes;
identify a first cluster of the one or more entities within the network graph, wherein the one or more entities within the first cluster correspond to a first hydrocarbon well of the one or more hydrocarbon wells; and
generate, on a display device, a visualization of the first hydrocarbon well including the one or more entities of the first cluster.

18. The system of claim 17 further comprising:
tokenizing each of the well attributes for the respective entities;
generating the similarity index between the one or more entities utilizing the tokenized well attributes for the respective entities; and
generating the network graph of the one or more entities, wherein a node of the network graph represents an entity, and wherein an edge of the network graph represents the similarity index between connected nodes.

19. The system of claim 17 further comprising:
increasing a similarity threshold of the similarity index; and
identifying the first cluster of the one or more entities, wherein the similarity index for the one or more entities are above the similarity threshold.

20. The system of claim 17 further comprising:
generating geo-spatial autocorrelation between the one or more entities to refine the first cluster, wherein the one or more entities with respective positive autocorrelation of similarity coefficients are selected to refine the first cluster; and
displaying each of the one or more entities from the refined first cluster on the visualization with a respective icon and a respective entity summary.
